(19) United States
(12) Patent Application Publication
(10) Pub. No.: US 2010/0329648 A1
(43) Pub. Date: Dec. 30, 2010

(54) SYSTEM AND METHOD OF ENSURING CORRECT EXECUTION OF A LABORATORY PROTOCOL OR PROCEDURE

(76) Inventors: Arbel D. TADMOR, Pasadena, CA (US); David Wu, Los Angeles, CA (US)

Correspondence Address: Steinfl & Bruno, 301 N Lake Ave Ste 810, Pasadena, CA, 91101, US

(21) Appl. No.: 12/823,087

(22) Filed: Jun. 24, 2010

Related U.S. Application Data
(60) Provisional application No. 61/220,529, filed on Jun. 25, 2009.

(51) Int. Cl. H04N 5/783; H04N 7/18

(52) U.S. Cl. 386/343; 348/143; 386/E05.003

(57) ABSTRACT

A system and a method of ensuring correct execution of a laboratory protocol or procedure are provided. An embodiment of the disclosure records videos of a bench area with a monitoring device, processes and stores the recorded video, and allows users to review the video. By reviewing the video of the lab procedure while conducting the laboratory protocol or procedure or shortly thereafter, users can resolve doubts and problems about particular steps of the lab procedure and conduct the procedure correctly.

### CROSS REFERENCE TO RELATED APPLICATIONS

The present application claims priority to U.S. Provisional Application No. 61/220,529 filed on Jun. 25, 2009, which is incorporated herein by reference in its entirety.

### FIELD

The present disclosure relates to video surveillance systems. More particularly, the disclosure relates to a method of using a video surveillance system to ensure correct execution of a laboratory protocol or procedure.

### SUMMARY

According to one aspect of the disclosure, a method of ensuring correct execution of a laboratory protocol or procedure is provided, the method comprising installing a monitoring device near a bench area, connecting an electronic computing device to the monitoring device, conducting a laboratory protocol, recording videos of the bench area with the monitoring device, storing and processing the recorded video on the electronic computing device, reviewing immediately the video by playing back, rewinding, fast forwarding, stepping backward, stepping forward, and zooming in or out the video; and resolving problems and uncertainties regarding the laboratory protocol.

According to a second aspect of the disclosure, a system for ensuring correct execution of a laboratory protocol or procedure is provided, the system comprising a monitoring device installed near a bench area, an electronic computing device coupled with the monitoring device, wherein the monitoring device is adopted to record the video of the bench area, and the electronic computing device is adopted to store and process the recorded video, and to enable users to resolve problems and uncertainties regarding the laboratory protocol by reviewing the video while conducting the laboratory protocol or procedure or shortly thereafter, wherein the reviewing includes playing back, rewinding, fast forwarding, stepping backward, stepping forward the videos.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 depicts an overview of an embodiment of the present disclosure.

FIG. 2 depicts a step-by-step operational procedure of an embodiment of the present disclosure.

FIG. 3 depicts a standby screenshot of an embodiment of the present disclosure.

FIG. 4 depicts a playback screenshot of an embodiment of the present disclosure.

FIG. 5 depicts an overview of an embodiment of the present disclosure, where a master electronic computing device and a plurality of client electronic computing assemblies are used.

### DETAILED DESCRIPTION

When a researcher is working in a laboratory, especially with chemicals or biological matter, a momentary lapse of concentration often leaves him to wonder whether he has performed a certain step correctly. Sometimes the step in doubt can be a crucial one and leaves the researcher no other recourse but to repeat the entire process. This repetition can be time-consuming, and often expensive if the process uses expensive reagents. Preparations may take hours and a few tens or hundreds of micro-liters of reagents may costs hundreds of dollars. For example, a biology protocol tends to have many sequential steps. Omitting a simple step, such as mixing a tube, can lead to an undesired outcome. Negligence, omissions and mistakes may lead to faulty or indeterminate results. In the medical discipline, erroneous procedures may cause life-endangering results. Accordingly, the present disclosure, in accordance with several embodiments, provides a method to ensure correct execution of a laboratory protocol or procedure. The present disclosure allows the researcher or someone who monitors the protocol or procedure to answer the question: “Did I do this step correctly?” The present disclosure may also be used in a hospital or other medical environments. In such a context, relevant professionals may use the disclosed system to ensure the correct execution of medical procedures, like medicine or treatment preparations. The present disclosure may also be used as a learning or teaching tool.

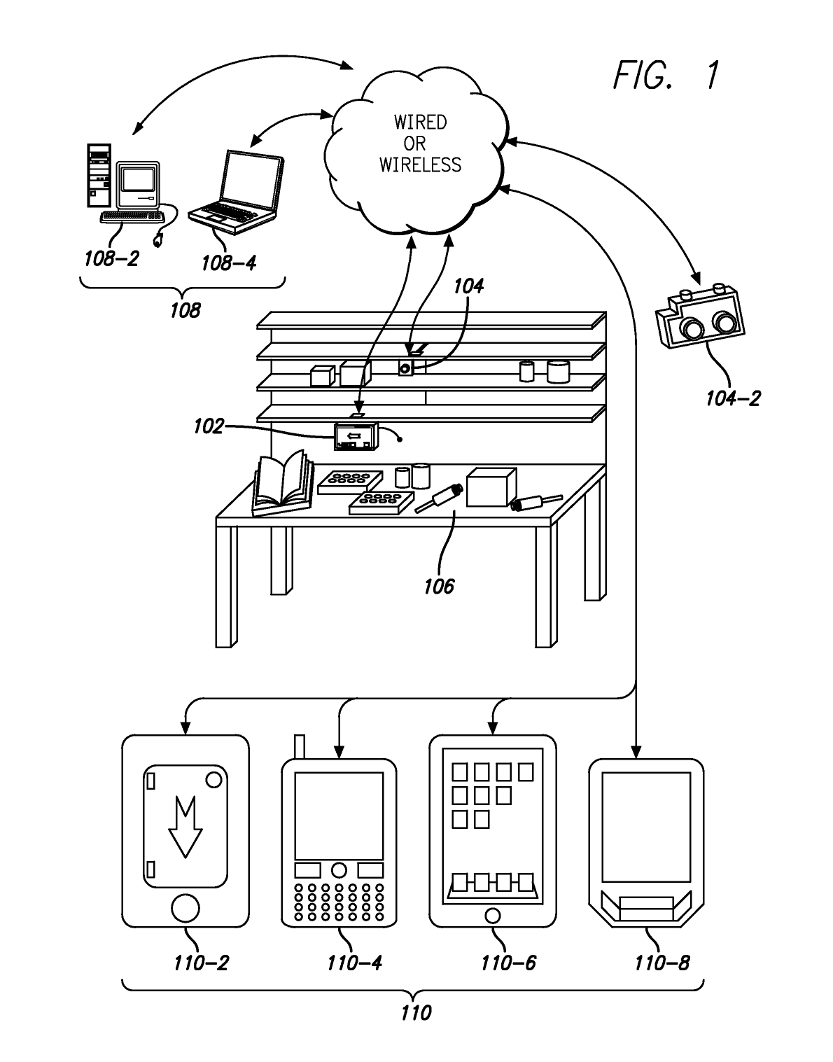

FIG. 1 shows a general overview of embodiments of the present disclosure. One such embodiment comprises a dedicated displaying device with a touch screen (102). The dedicated displaying device (102) is connected to a camera (104), which is installed near the bench area (106). The dedicated displaying device (102) may connect to the camera (104) in a wired or wireless manner. The dedicated displaying device (102) receives, processes, stores, and displays video signals, and processes inputs from the touch screen. In a further embodiment of the present disclosure, the dedicated displaying device (102) may use a stylus or a keyboard or mouse as user input.

The camera (104) may be a wide-field camera, a narrow-field camera, a surgical fiber-optic camera, or other monitoring devices that are capable of capturing videos or monitoring an area. A further embodiment of the camera is a device that collects light from two different angles, for example, a two-lens camera (104-2). Such a two-lens camera allows viewing the bench area (106) from two slightly different angles to see past obstructing obstacles. Another embodiment of the present disclosure is capable of rendering three-dimensional video via the two-lens camera (104-2).

A still further embodiment of the present disclosure uses a computer (108-2), a laptop (108-4), or a similar electronic computing device, instead of a dedicated displaying device with a touch screen. The computer (108) may connect to the camera (104) in a wired or wireless manner. Examples of computers include a laptop (108-4), a desktop computer (108-2), and a tablet computer.

Still another embodiment of the present disclosure uses a mobile electronic (110) device in place of a dedicated displaying device with a touch screen. The mobile electronic device (110) may be a cell phone (110-4), a MP3 player (110-2), a tablet computer (110-6), a PDA (110-8), etc. The mobile electronic device (110) may connect to the camera (104) wirelessly through cellular network, WiFi network, Bluetooth, etc. The mobile electronic device may also connect to the camera in a wired manner. The computer (108) or the mobile electronic device may be located remotely, for example, in a different room or a different building from the laboratory or in a different location.

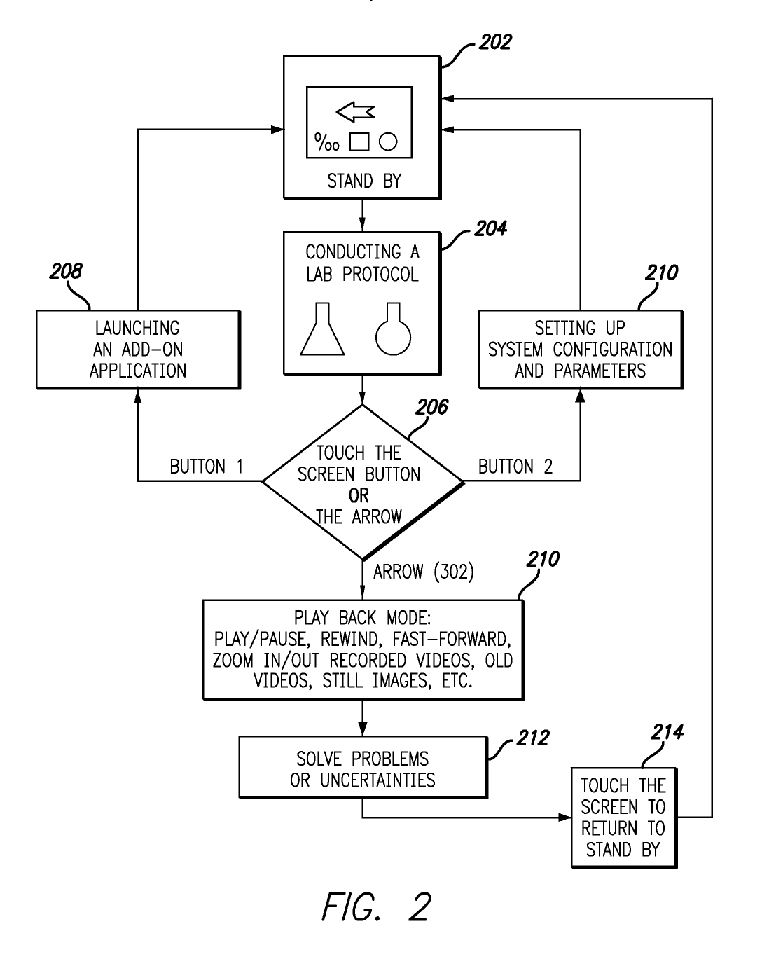

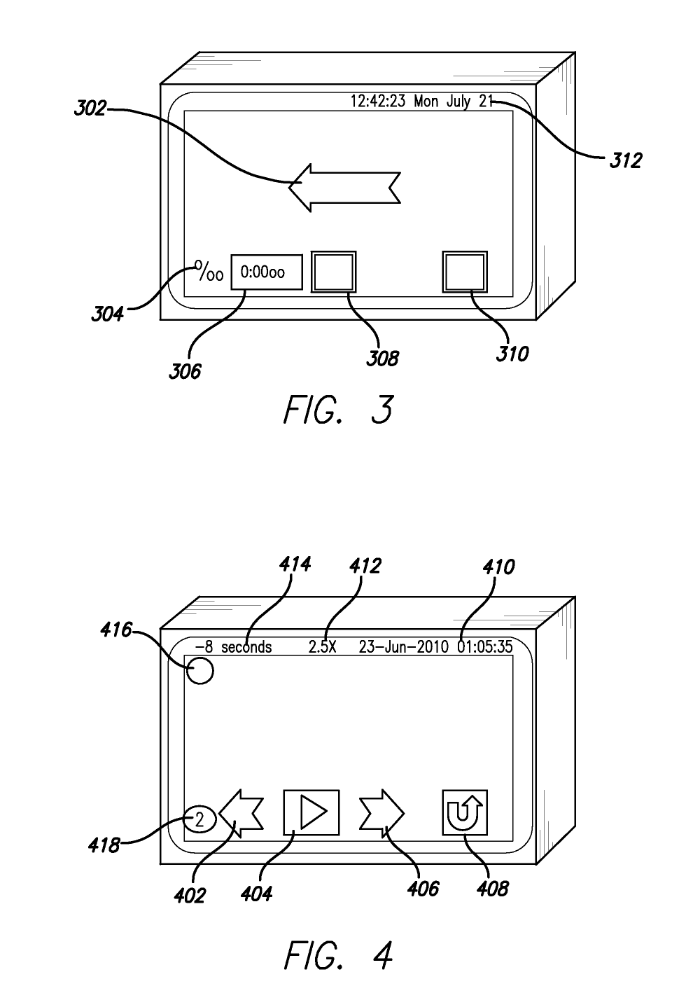

FIG. 2 shows a series of operations according to an embodiment of the present disclosure. FIG. 3 shows a standby screenshot of an embodiment of the present disclosure, where a touch screen is present. First, a standby mode (202) is established. The researcher is conducting a laboratory protocol or procedure (204) and the camera (104) is recording a video of the researcher and his bench area. The displaying device (102) processes and stores the video. The video may be encoded and compressed with non-uniform compression rate, frame rate, or resolution. Older videos may be encoded and compressed with a higher compression rate, a lower frame rate, or a lower resolution, while more recent videos may be encoded and compressed with a lower compression rate, a high frame rate or a higher resolution.

When the standby mode (202) occurs, the displaying device (102) is displaying a large arrow (302) or some other icon, together with date and time (312). At the same time, the researcher may launch add-on applications (208) by touching the screen (206) or using the user interface. The add-on applications include, for example, a calculator, a timer, a molecular weight converter, a calculation tool helping to pH a buffer, or other useful applications. The researcher may download from a dedicated website the add-on applications and install them on the displaying device (102). The researcher may start the timer application by touching the screen button (304), the timer application by touching the screen button (306), or other add-on applications by touching the screen button (308). After using the add-on application, the standby mode (202) occurs again. When the standby mode (202) occurs, the researcher may also view a live video of the bench top, set exposure and contrast conditions, resolution, frame rate, compression options, recording time, set time and date, choose a file to playback, a saved still image, set the video loop length, etc., (210) by touching the screen button (310) or through other user interface.

When the researcher has doubts about the steps of the protocol he has performed, or when he wants to review the procedure he (or someone else) has performed, he can touch or click the arrow (302) on the screen (or other input from the user interface) (206), and the playback mode (210) appears.

FIG. 4 shows a screenshot of an embodiment of the present disclosure in the playback mode (210). When the playback mode (210) occurs, the camera (102) stops recording. The displaying device (104) displays the playback time from present (414), the time lapsed (414), and the exact time the video is showing (410). Through the touch screen or other user interface, the researcher can rewind (402), pause/play (404), and fast forward (406) the video. The researcher may step forward and backward, or jump to a certain point via a scroll bar.

In addition, the researcher can zoom in the video in real time or in pause mode through the touch screen or other user interface. The magnification level (412) is shown on the screen. The researcher can rewind, pause/play, fast forward, and step forward/backward the zoomed video. Furthermore, the researcher can adjust the screen contrast (416) through the touch screen or other user interface. For the embodiment of the present disclosure, where the camera with two lenses is used, the researcher may switch (418) between video taken from the two different lenses to avoid obstructing obstacles.

By reviewing the video of the procedures he has performed, the researcher can resolve his doubts and uncertainties regarding the procedure or protocol (212). For example, the researcher can know whether he has added a particular reagent to specific test tubes. After solving his problem, the researcher can put the embodiment back to the standby mode (202) through the touch screen (408) or other user interface (214). Besides, the researcher can save videos for future reference. The researcher may also transfer videos to a different device with a flash drive or by connecting to another computer.

A further embodiment of the present disclosure further comprises a microphone and speakers. A researcher or a teacher can use the embodiment to demonstrate a work protocol or technique and record the process for future distribution.

A still further embodiment of the present disclosure further comprises a communication link for uploading and downloading images and video and for controlling and monitoring the embodiment. The communication link may be wired or wireless, such as USB, WiFi, Ethernet, cellular network, etc. In addition to recording videos, the researcher can take still images of a certain bench setup for future reference. The researcher can also download a video clip for the procedure he would like to execute. Such a video clip may come from a dedicated website or be prepared by the researcher or others. Students or trainees may download a pre-recorded video clip to the embodiment to follow a particular protocol step by step.

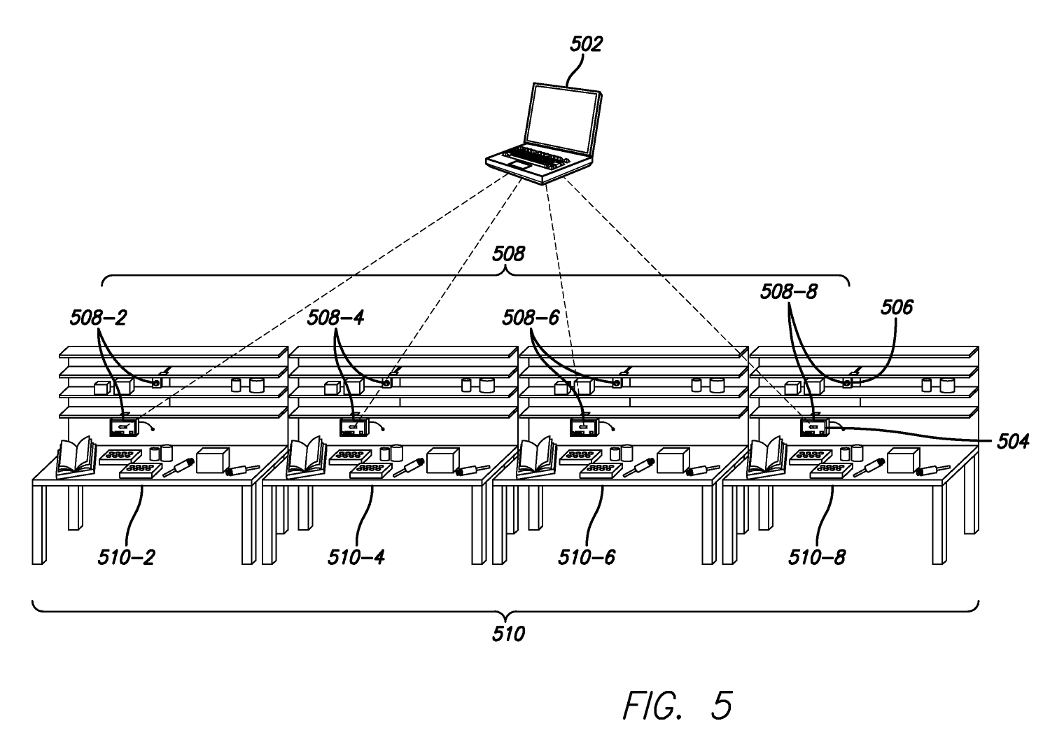

FIG. 5 shows a further embodiment of the present disclosure, where a master electronic computing device (502) and a plurality of client electronic computing assemblies (508) are used. The number of client electronic computing assemblies may be one, two, or more. The client electronic assembly (508) comprises a client electronic computing device (504) coupled to a camera (506) that is installed near an individual bench area (510). The master electronic computing device (502) is coupled to a plurality of client electronic computing assemblies (508) in a wired or wireless manner. Through the master electronic computing device (502), teachers or trainers may view recorded or live video, taken by the client electronic computing assemblies (508), of each lab area (510) of each student or trainee. In addition, teacher and trainers may control the video playback on the client electronic computing assemblies (508). The master electronic computing device (502) and the client electronic computing assemblies (508) may be located locally or remotely, for example, in different rooms or buildings or an entirely different location.

Another embodiment of the present disclosure may display advertisement messages on the screen while the embodiment is in the standby mode. Still another embodiment of the present disclosure has a social networking client, allowing researchers to interact with users of other embodiments when the standby mode occurs.

A further embodiment of the present disclosure has one or a plurality of sensors that detect the researcher's presence. When the sensors detect that the researcher is before the bench, the system automatically starts recording videos. When the sensors detect that no one is before the bench, the system automatically stops recording videos.

The examples set forth above are provided to give those of ordinary skill in the art a complete disclosure and description of how to make and use the embodiments of the system and method of ensuring correct execution of a laboratory protocol or procedure of the disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

1. A method of ensuring correct execution of a laboratory protocol or procedure, comprising:
installing a monitoring device near a bench area;
connecting an electronic computing device with the monitoring device;
recording videos of the bench area with the monitoring device;
storing and processing the recorded video on the electronic computing device; and
enabling users to resolve problems and uncertainties regarding the laboratory protocol by reviewing the video while conducting the laboratory protocol or procedure or shortly thereafter, wherein the reviewing includes playing back, rewinding, fast forwarding, stepping backward, stepping forward the videos.

2. The method according to claim 1, further comprising: zooming in or out the videos while the videos are playing, paused, rewinding, or fast-forwarding.

3. The method according to claim 1, further comprising:
providing application programming interfaces for add-on applications to add additional functions; and
providing the add-on applications configured to be executed while the monitoring device is recording.

4. The method according to claim 1, further comprising:
displaying advertisement messages on the electronic computing device while the monitoring device is recording video.

5. The method according to claim 1, wherein the electronic computing device is wirelessly connected to the monitoring device.

6. The method according to claim 1, wherein the add-on application is a timer, a calculator, a social networking client, a molecular weight converter, or a pH buffer calculator.

7. The method according to claim 1, wherein the monitoring device is a wide-field camera or a camera with two lenses.

8. The method according to claim 1, wherein the electronic computing device is a computer, a laptop, a mobile electronic device, a cell phone, or a displaying device integrated with a touch screen and the displaying device is adapted to receive, process, store, and display video signals, and to process inputs from the touch screen.

9. The method according to claim 1, wherein the recoded video is encoded and compressed with non-uniform compression rates, frame rates and resolutions.

10. The method according to claim 1, further comprising recording a laboratory protocol or procedure and to distributing the recorded laboratory protocol or procedure to other electronic computing devices.

11. The method according to claim 1, further comprising:
downloading an additional video to the electronic computing device; and
enabling users to follow and correctly conduct the laboratory protocol or procedure by reviewing the video by playing back, rewinding, fast forwarding, stepping backward, stepping forward, and zooming in or out the additional video.

12. The method according to claim 1, further comprising:
installing a plurality of client electronic computing assemblies near a plurality of bench areas, wherein each client electronic assembly comprises a client electronic computing device and a camera;
connecting the plurality of client electronic computing assemblies to a master electronic computing device;
monitoring each bench area via the master electronic computing device; and
controlling the playing of the video on the plurality of client electronic computing assemblies.

13. A system for ensuring correct execution of a laboratory protocol or procedure, comprising:
a monitoring device, installed near a bench area; and
an electronic computing device, coupled with the monitoring device;
wherein the monitoring device is adopted to record a video of the bench area, and the electronic computing device is adapted to store and process the recorded video, and to enable users to resolve problems and uncertainties regarding the laboratory protocol by reviewing the video while conducting the laboratory protocol or procedure or shortly thereafter, wherein the reviewing includes playing back, rewinding, fast forwarding, stepping backward, and stepping forward the videos.
